(19) United States
(12) Patent Application Publication
(10) Pub. No.: US 2022/0188851 A1
(43) Pub. Date: Jun. 16, 2022

(54) MULTI-OBJECTIVE DISTRIBUTIONAL REINFORCEMENT LEARNING FOR LARGE-SCALE ORDER DISPATCHING

(71) Applicant: Beijing DiDi Infinity Technology and Development Co., Ltd., Beijing (CN)

(72) Inventors: Fan ZHOU, Shanghai (CN); Xiaocheng TANG, Mountain View, CA (US); Zhiwei QIN, Mountain View, CA (US); Fan ZHANG, Beijing (CN); Hongtu ZHU, Beijing (CN)

(21) Appl. No.: 17/059,247

(22) PCT Filed: Jun. 2, 2020
(86) PCT No.: PCT/CN2020/093952

§ 371 Date: Nov. 26, 2020

(51) Int. Cl. G06Q 30/02; G06Q 50/30; G01C 21/34

(52) U.S. Cl. CPC G06Q 30/0206; G06Q 50/30; G01C 21/3461; G01C 21/3484; G01C 21/3438

(57) ABSTRACT

Multi-objective distributional reinforcement learning may be applied to order dispatching on ride-hailing platforms. A set of historical driver trajectories and a set of driver-order pairs may be obtained. A weight vector between a first reward of the set of historical driver trajectories and a second reward of the set of historical driver trajectories may be determined using inverse reinforcement learning (IRL). A first value function and a second value function may be jointly learned using distributional reinforcement learning (DRL) based on the historical driver trajectories and the weight vector. A set of scores comprising a score of each driver-order pair in the set of driver-order pairs may be determined based on the weight vector, the first value function, and the second value function. A set of dispatch decisions may be determined based on the set of scores that maximizes a total reward of the set of dispatch decisions.

### TECHNICAL FIELD

The disclosure relates generally to dispatching orders on ridesharing platforms, and more specifically, to methods and systems for dispatching orders to vehicles based on multi-objective reinforcement learning.

### BACKGROUND

The rapid development of mobile internet service in the past few years has allowed the creation of large scale online ride hailing services. These services may substantially transform the transportation landscape of human beings. By using advanced data storage and processing technologies, the ride-hailing systems may continuously collect and analyze real-time travelling information, dynamically updating the platform policies to significantly reduce driver idle rates and passengers' waiting time. The services may additionally provide rich information on demands and supplies, which may help cities establish an efficient transportation management system.

### SUMMARY

Various embodiments of the specification include, but are not limited to, systems, methods, and non-transitory computer readable media for order dispatching.

In various implementations, a method may include obtaining a set of historical driver trajectories and a set of driver-order pairs. Each trajectory in the set of historical driver trajectories may include a sequence of states and actions of a historical driver, and each driver-order pair of the set of driver-order pairs may include a driver and a pending order. The method may further include determining a weight vector between a first reward of the set of historical driver trajectories and a second reward of the set of historical driver trajectories using inverse reinforcement learning (IRL). The method may further include jointly learning a first value function and a second value function using distributional reinforcement learning (DRL) based on the historical driver trajectories and the weight vector, wherein the first value function and the second value function comprise distributions of expected returns of future dispatch decisions. The method may further include determining a set of scores comprising a score of each driver-order pair in the set of driver-order pairs based on the weight vector, the first value function, and the second value function. The method may further include determining a set of dispatch decisions based on the set of scores that maximizes a total reward of the set of dispatch decisions, wherein each dispatch decision in the set of dispatch decisions comprises at least matching an available driver to a passenger.

In another aspect of the present disclosure, a computing system may comprise one or more processors and one or more non-transitory computer-readable memories coupled to the one or more processors and configured with instructions executable by the one or more processors. Executing the instructions may cause the system to perform operations. The operations may include obtaining a set of historical driver trajectories and a set of driver-order pairs. Each trajectory in the set of historical driver trajectories may include a sequence of states and actions of a historical driver, and each driver-order pair of the set of driver-order pairs may include a driver and a pending order. The method may further include determining a weight vector between a first reward of the set of historical driver trajectories and a second reward of the set of historical driver trajectories using inverse reinforcement learning (IRL). The method may further include jointly learning a first value function and a second value function using distributional reinforcement learning (DRL) based on the historical driver trajectories and the weight vector, wherein the first value function and the second value function comprise distributions of expected returns of future dispatch decisions. The method may further include determining a set of scores comprising a score of each driver-order pair in the set of driver-order pairs based on the weight vector, the first value function, and the second value function. The method may further include determining a set of dispatch decisions based on the set of scores that maximizes a total reward of the set of dispatch decisions, wherein each dispatch decision in the set of dispatch decisions comprises at least matching an available driver to a passenger.

Yet another aspect of the present disclosure is directed to a non-transitory computer-readable storage medium configured with instructions executable by one or more processors to cause the one or more processors to perform operations. The operations may include obtaining a set of historical driver trajectories and a set of driver-order pairs. Each trajectory in the set of historical driver trajectories may include a sequence of states and actions of a historical driver, and each driver-order pair of the set of driver-order pairs may include a driver and a pending order. The method may further include determining a weight vector between a first reward of the set of historical driver trajectories and a second reward of the set of historical driver trajectories using inverse reinforcement learning (IRL). The method may further include jointly learning a first value function and a second value function using distributional reinforcement learning (DRL) based on the historical driver trajectories and the weight vector, wherein the first value function and the second value function comprise distributions of expected returns of future dispatch decisions. The method may further include determining a set of scores comprising a score of each driver-order pair in the set of driver-order pairs based on the weight vector, the first value function, and the second value function. The method may further include determining a set of dispatch decisions based on the set of scores that maximizes a total reward of the set of dispatch decisions, wherein each dispatch decision in the set of dispatch decisions comprises at least matching an available driver to a passenger.

In some embodiments, the set of historical driver trajectories may have occurred under an unknown background policy.

In some embodiments, the first reward may correspond to collected total fees and the second reward may correspond to a supply and demand balance.

In some embodiments, the weight vector may be determined iteratively by using IRL to match estimations of action-state sequences to the set historical driver trajectories.

In some embodiments, jointly learning the first value function and the second value function using DRL based on the historical driver trajectories and the weight vector may include obtaining a subset of trajectories from the set of historical driver trajectories. A set of augmented trajectories may be obtained by augmenting the subset of trajectories with contextual features. A trajectory probability may be determined by sampling a range from the set of augmented trajectories. A weighted temporal difference (TD) error may be determined based on the trajectory probability. A loss may be determined based on the weighted TD error. The first weights of the first value function and second weights of the second value function may be updated based on the gradient of the loss.

In some embodiments, jointly learning the first value function and the second value function using DRL based on the historical driver trajectories and the weight vector may include determining first optimal values of the first weights of the first value function and second optimal values of the second weights of the second value function to optimize at least one of order dispatching rate, passenger waiting time, or driver idle rates.

In some embodiments, the score of each driver-order pair may be based on a TD error between an expected return if the driver of the driver-order pair accepts the pending order and an expected return if the driver stays idle.

In some embodiments, the passenger may be matched with a plurality of available drivers.

In some embodiments, the set of dispatch decisions may be added to the set of historical driver trajectories to re-determine the weight vector and re-learn the first value function and the second value function for dispatching a new set of driver-order pairs.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an exemplary system to which techniques for dispatching orders may be applied, in accordance with various embodiments.

FIG. 2 illustrates an exemplary algorithm for learning a weight vector, in accordance with various embodiments.

FIG. 3 illustrates an exemplary algorithm for multi-objective distributional reinforcement learning, in accordance with various embodiments.

FIG. 4 illustrates a flowchart of an exemplary method, according to various embodiments of the present disclosure.

FIG. 5 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein relate to a multi-objective distributional reinforcement learning based order dispatch algorithm in large-scale on-demand ride-hailing platforms. In some embodiments, reinforcement learning based approaches may only pay attention to total driver income and ignore the long-term balance between the distributions of supplies and demands. In some embodiments, the dispatching problem may be modeled as a Multi-Objective Semi Markov Decision Process (MOSMDP) to account for both the order value and the supply-demand relationship at the destination of each ride. An Inverse Reinforcement Learning (IRL) method may be used to learn the weights between the two targets from the drivers' perspective under the current policy. Fully Parameterized Quantile Function (FQF) may then be used to jointly learn the return distributions of the two objectives, and re-weights the importance in the final on-line dispatching planning to achieve the optimal market balance. As a result, the platform's efficiency may be improved.

The order dispatching problem in ride-hailing platforms may be treated as a sequential decision making problem to keep assigning available drivers to nearby unmatched passengers over a large scale spatial-temporal region. A well-designed order dispatching policy should take into account both the spatial extent and the temporal dynamics, measuring the long-term effects of the current assignments on the balance between future demands and supplies. In some embodiments, a supply-demand matching strategy may allocate travel requests in the current time window to nearby idle drivers following the “first-come first-served” rule, which may ignore the global optimality in both the spatial and temporal dimensions. In some embodiments, order dispatching may be modeled as a combination optimization problem, and global capacity may be optimally allocated within each decision window. Spatial optimization may be obtained to a certain extent while still ignoring long-term effects.

Reinforcement learning may be used to capture the spatial-temporal optimality simultaneously. Temporal difference (TD) may be used to off-line learn the spatial-temporal value by dynamic programming, which may be stored in a discrete tabular and applied in on-line real-time matching. Deep Q-learning algorithm may be used to estimate the state-action value and improve the sample complexity by employing a transfer learning method to leverage knowledge transfer across multiple cities. The supply-demand matching problem may be modeled as a Semi Markov Decision Process (SMDP), and may use the Cerebellar Value Network (CVNet) to help improve the stability of the value estimation. These reinforcement learning based approaches may not be optimal from the perspective of balancing the supply-demand relationship since they only focus on maximizing the cumulative return of supplies but ignore the user experience of passengers. For example, supply loss in a certain area may transfer the region from a “cold” zone (fewer demands than supplies) to a “hot” one (more demands than supplies), thereby increasing the waiting time of future customers and reducing their satisfaction with the dispatching services.

In some embodiments, a multi-objective reinforcement learning framework may be used for order dispatching, which may simultaneously consider the drivers' revenues and the supply-demand balance. A SMDP formulation may be followed by allowing temporally extended actions while assuming that each single agent (e.g., driver) makes serving decisions guided by an unobserved reward function, which can be seen as the weighted sum of the order value and the spatial-temporal relationship of the destination. The reward function may first be learned based on the historical trajectories of hired drivers under an unknown background policy.

In some embodiments, distributional reinforcement learning (DRL) may be used to more accurately capture intrinsic randomness. DRL aims to model the distribution over returns, whose mean is the traditional value function. Considering the uncertainty of order values and the randomness of driver movements, most recent FQF based method may be used to jointly learn the reward distributions of the two separate targets and quantify the uncertainty which arises from the stochasticity of the environment.

In planning, the Temporal-Difference errors of the two objectives may be tuned when determining the value of each driver-passenger pair. The method may be tested by comparing with some state-of-art dispatching strategies in a simulator built with real-world data and in a large-scale application system. According to some experimental results, the method can not only improve the Total Driver Income (TDI) in the supply side but also increase the order answer rate (OAR) in simulated AB test environment.

The order dispatching problem may be modeled as a MOSMDP. An IRL method may be used to learn the weight between the two rewards, order value and supply-demand relationship, under the background policy. A DRL based method may be used to jointly learn the distributions of the two returns, which considers the intrinsic randomness within the complicated ride-hailing environment. The importance of the two objectives may be reweighted in planning to improve some key metrics on both supply and demand sides by testing in an extensive simulation system.

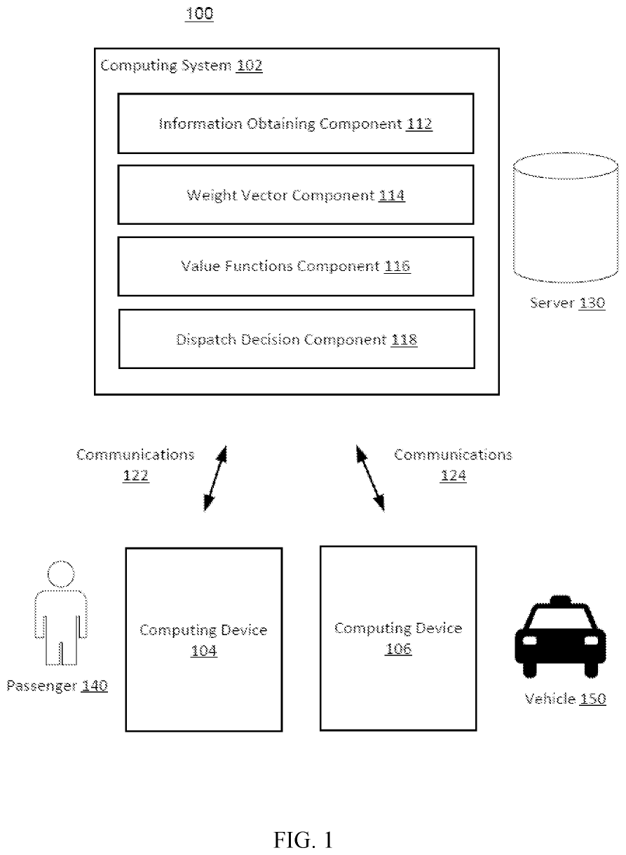

FIG. 1 illustrates an exemplary system 100 to which techniques for dispatching orders may be applied, in accordance with various embodiments. The example system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers (e.g., server 130), or one or more clouds. The server 130 may include hardware or software which manages access to a centralized resource or service in a network. A cloud may include a cluster of servers and other devices which are distributed across a network.

The computing devices 104 and 106 may be implemented on or as various devices such as a mobile phone, tablet, server, desktop computer, laptop computer, etc. The computing devices 104 and 106 may each be associated with one or more vehicles (e.g., car, truck, boat, train, autonomous vehicle, electric scooter, electric bike, etc.). The computing devices 104 and 106 may each be implemented as an in-vehicle computer or as a mobile phone used in association with the one or more vehicles. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

In some embodiments, the system 100 may include a ridesharing platform. The ridesharing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ridesharing platform.

The computing system 102 may receive the request and reply with price quote data and price discount data for one or more trips. The price quote data and price discount data for one or more trips may be included in communications 122. When the passenger 140 selects a trip, the computing system 102 may relay trip information to various drivers of idle vehicles. The trip information may be included in communications 124. For example, the request may be posted to computing device 106 carried by the driver of vehicle 150, as well as other commuting devices carried by other drivers. The driver of vehicle 150 may accept the posted transportation request. The acceptance may be sent to computing system 102 and may be included in communications 124. The computing system 102 may send match data to the passenger 140 through computing device 104. The match data may be included in communications 122. The match data may also be sent to the driver of vehicle 150 through computing device 106 and may be included in communications 124. The match data may include pick-up location information, fees, passenger information, driver information, and vehicle information. The matched vehicle may then be dispatched to the requesting passenger. The fees may include transportation fees and may be transacted among the system 102, the computing device 104, and the computing device 106. The fees may be included in communications 122 and 124. The communications 122 and 124 may additionally include observations of the status of the ridesharing platform. For example, the observations may be included in the initial status of the ridesharing platform obtained by information component 112 and described in more detail below.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. The computing system 102 may include an information obtaining component 112, a weight vector component 114, a value functions component 116, and a dispatch decision component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the system 100.

The information obtaining component 112 may be configured to obtain a set of historical driver trajectories and a set of driver-order pairs. Obtaining information may include one or more of accessing, acquiring, analyzing, determining, examining, identifying, loading, locating, opening, receiving, retrieving, reviewing, storing, or otherwise obtaining the information. Each trajectory in the set of historical driver trajectories may include a sequence of states and actions of a historical driver. The actions may have been taken in the past, and the actions may include matching with a historical order, remaining idle, or relocating. In some embodiments, the set of historical driver trajectories may have occurred under an unknown background policy. For example, unknown factors (e.g., incentives, disincentives) may have influenced decisions made by the historical driver. Each driver-order pair of the set of driver-order pairs may include a driver and a pending order (i.e., passenger) which may be matched in the future.

Order dispatching may be modeled as a SMDP with a set of temporal actions, known as options. Under the framework of SMDP, each agent (e.g., driver) may interact episodically with the environment (e.g., ride-hailing platform) at some discrete time scale,t∈T:={0, 1, 2, . . . , T} until the terminal timestep T is reached. A driver's historical interactions with the ride-hailing platform may be collected as a trajectory that comprises a plurality of state-action pairs. Within each action window t, the driver may perceive the state of the environment and the driver him/herself, described by the feature vector sₜ ∈S, and on that basis an option oₜ˜π(·|sₜ) ∈O that terminates in sₜ, ∈P(·|sₜ, oₜ) where t′=t+Δₒ_{ₜ}·π: S×O→[0, 1] here denotes a stochastic policy. As a response, the environment may produce numerical reward Rₜ₊ᵢ, for each intermediate step, e.g., i=1, . . . , Δoₜ. The following specifics may be included in the context of order dispatching.

A state formulation may be adopted in which the sₜ includes the geographical status of the driver lₜ, the raw time stamp μₜ as well as the contextual feature vector given by νₜ, i.e., sₜ:=(lₜ, μₜ, νₜ). In some embodiments, the spatial-temporal contextual features νₜ may contain only the static features.

An option, denoted as oₜ, may represent the temporally extended action a driver takes at state sₜ, ending effects at s_{t+Δ} where Δₜ=0, 1, 2, . . . is the duration of the transition which finishes once the driver reaches the destination. Executing option oₜ at state sₜ may result in a transition from the starting state sₜ to the destination s_{t+Δ}_{ₜ}, according to the transition probability P (s_{t+Δ}_{ₜ}|oₜ, sₜ). This transition may happen due to either a trip assignment or an idle movement. Thus, oₜ=1 when the driver accepts a trip request, and oₜ=0 if the driver keeps staying idle. Different oₜ may take different time steps to finish and the time extension is often larger than 1, e.g., Δₜ>1.

The reward may include the total reward received by executing option oₜ at state sₜ. In some embodiments, only drivers' revenue is maximized. In some embodiments, a Multi-objective reinforcement learning (MORL) framework may be used to consider not only the collected total fees R₁(sₜ, oₜ) but also the spatial-temporal relationship R₂(sₜ, oₜ) in the destination state s_{t′}. In some embodiments, the interaction effects may be ignored when multiple drivers are being re-allocated by completed order servings to a same state sₜ, which may influence the marginal value of a future assignment R₁(s_{t′}, o_{t′}). In this case, oₜ=1 may result in both non-zero R₁ and R₂, while oₜ=0 may lead to a transition with zero R₁ but non-zero R₂ that ends at the place where the next trip option is activated. In some embodiments in which the environment includes multiple objectives, the feedback of the SMDP may return a vector rather than a single scalar value, i.e.: R(sₜ, oₜ)=(R₁(sₜ, oₜ), R₂(sₜ, oₜ))^{T} where each Rᵢ(sₜ, oₜ)=Σⱼ₌₀^{Δ}^{ₜ}⁻¹rᵢ₍ₜ₊ⱼ₎ for i∈{1, 2}. In the case of order dispatching, both R₁(sₜ, oₜ) and R₂(sₜ, oₜ) collected by taking action oₜ may be spread uniformly across the trip duration. A discounted accumulative reward \hat{R}i may be calculated as:

$${\hat{R}}_{i} ( {s}_{t} , {o}_{t} ) = \frac{{R}_{i} ( {s}_{t} , {o}_{t} )}{{Δ}_{t}} + γ \frac{{R}_{i} ( {s}_{t} , {o}_{t} )}{{Δ}_{t}} + … + {γ}^{{Δ}_{t} - 1} \frac{{R}_{i} ( {s}_{t} , {o}_{t} )}{{Δ}_{t}} = \frac{{R}_{i} ( {s}_{t} , {o}_{t} ) ( {γ}^{{Δ}_{t} - 1} )}{{Δ}_{t} ( γ - 1 )} , where 0 < γ < 1 , {D}_{t} \geq 1 for i ∈ \{ 1 , 2 \} . \qquad ( 1 )$$

The policy π(o|s) may specify the probability of taking option o in state s regardless of the time step t. Executing π in the environment may generate a history of driver trajectories denoted as

$$\{ {τ}_{k} \} ∈ H := \{ ( {s}_{{kt}_{0}} , {o}_{{kt}_{0}} , … , {s}_{{kt}_{{T}_{{τ}_{k}}}} \}$$

where each tⱼ is the time index of the j-th activated state along the trajectory τₖ. Z^{π}(s)=(Z₁^{π}(s), Z₂^{π}(s))^{T} may be used to denote the random variable of the cumulative reward that the driver will gain starting from s and following π for both objectives. The expectation of Z^{π}(s) is V^{π}(s)= [symbol] _{π,p,R}(Zπ(s)), which is the state value function. The Bellman equation for V^{π}(s) may be:

V^{π}(s)= [symbol] [\hat{R}(sₜ,oₜ)++γ^{Δ}^{ₜ}V^{π}(s_{t+Δ}_{ₜ})|sₜ=s]

sₜ+Δₜ˜P(·|sₜ,oₜ),oₜ˜π(·|sₜ) (2)

The distributional Bellman equation for the state-action value distribution zit may be extended to the multi-objective case as:

Z^{π}(sₜ): [symbol] \hat{R}(sₜ,oₜ)+γ^{Δ}^{ₜ}Z^{π}(s_{t+Δ}_{ₜ})

sₜ+Δₜ˜P(·|sₜ,oᵢ),oₜ˜π(·|sₜ) (3)

where [symbol] denotes distributional equivalence.

In some embodiments, a Multi-Objective Distributional Reinforcement Learning (MODRL) may be used to learn the state value distribution (Z^{π}(s)=(Z₁^{π}(s), Z₂^{π}(s))^{T} and its expectation V^{π}(s) under the background policy π by using the observed historical trajectories. The MOSMDP may employ scalarization functions to define a scalar utility over a vector-valued policy to reduce the dimensionality of the underlying multi-objective environment, which may be obtained through an IRL based approach. FQF may then be used to learn the quantile approximation of Z^{π}(s) and its expectation V^{π}(s).

The weight vector component 114 may be configured to determine a weight vector between a first reward of the set of historical driver trajectories and a second reward of the set of historical driver trajectories using inverse reinforcement learning (IRL). In some embodiments, the first reward may correspond to collected total fees and the second reward may correspond to a supply and demand balance. For example, the supply and demand balance may include a spatial temporal relationship between a supply and demand.

In some embodiments, reinforcement learning on multi-objective tasks may rely on single-policy algorithms which transfer the reward vector into a scalar. In some embodiments, the scalarization f may be a function that projects \hat{R} to a scalar by a weighted linear combination:

U=f(\hat{R},W)=W^{T}\hat{R}, (4)

where W=(w1, w2)^{T} is a weight vector parameterizing f. In some embodiments, the weight vector may be determined iteratively by using IRL to match estimations of action-state sequences to the set historical driver trajectories.

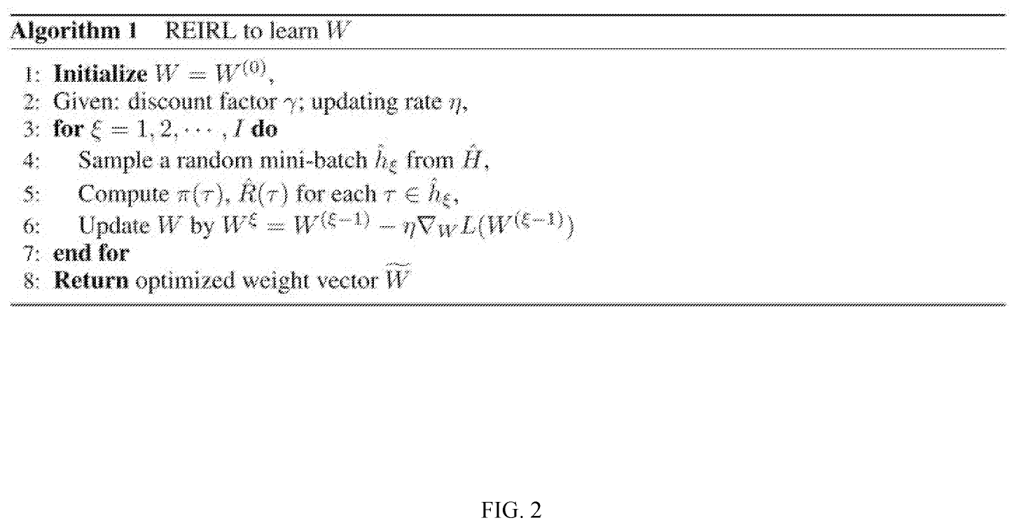

FIG. 2 illustrates an exemplary algorithm for learning a weight vector, in accordance with various embodiments. In some embodiments, the algorithm may be implemented by the weight vector component 114 of FIG. 1. In some embodiments, IRL may be used to learn a reward function of an MDP. IRL methods may find a reward function such that the estimations of action-state sequences under a background policy matches the observed historical trajectories which are sampled according to the policy and the intrinsic transition probabilities of the system. The cumulative reward for each objective i∈{1, 2} along a trajectory τ may be defined as:

$${\hat{R}}_{i} ( τ ) = {\sum }_{j = 0}^{{T}_{τ}} {γ}^{{l}_{i}} \hat{R} ( {s}_{{t}_{j}} , {o}_{{t}_{j}} ) \qquad ( 5 )$$

In some embodiments, the expected return under policy π may be written as a linear function of the reward expectations W^{T}\hat{R}(τ) where \hat{R}(τ)=(\hat{R}₁(τ), \hat{R}₂(τ))^{T}:

$$J ( π ) = {\sum }_{τ ∈ ℋ} P ( τ \vert π , T ) {W}^{T} \hat{R} ( τ ) \qquad ( 6 )$$

where H denotes the set of driver trajectories and T denotes the transition function.

Apprenticeship learning may be used to learn a policy that matches the background policy demonstrated by the observed trajectories, i.e.

$${\sum }_{τ ∈ H} P ( τ ) \hat{R} ( τ ) = \tilde{R} \qquad ( 7 )$$

where \tilde{R} is empirical expectation of \hat{R}(τ) based on collective trajectories \tilde{H}. In some embodiments, the maximum likelihood estimate of W may be estimated using gradient decent method with gradient given by:

\tilde{R}−Σ_{τ∈\tilde{H}}P(τ)\hat{R}(τ). (8)

In some embodiments, likelihood function may be unable to be calculated because the transition function T in P (τ) cannot be easily computed considering the system complexity and the limited observed trajectories. In some embodiments, Relative Entropy IRL based on Relative Entropy Policy Search (REPS) and Generalized Maximum Entropy methods may use importance sampling to estimate F=Σ_{τ∈h}P(τ)\hat{R}(τ) as follows:

$$F = {\sum }_{τ ∈ \hat{h}} P ( τ ) \hat{R} ( τ ) = {\sum }_{τ ∈ \hat{h}} \frac{U ( τ ) {π ( τ )}^{- 1} {e}^{{W}^{T} \hat{R} ( τ )}}{{\sum }_{τ ∈ \hat{h}} U ( {τ}^{′} ) {π ( {τ}^{′} )}^{- 1} {e}^{{W}^{T} \hat{R} ( {τ}^{′} )}} \hat{R} ( τ ) \qquad ( 9 )$$

where ĥ may include a small batch sampled from the whole collective trajectory set Ĥ. U(τ) may include the uniform distribution and π(τ) may include the trajectory distribution from the background policy π which is defined as:

$$π ( τ ) = {\prod }_{j = 1}^{{T}_{i}} P ( {o}_{{t}_{j}} \vert {s}_{{t}_{j}} ) \qquad ( 10 )$$

In some embodiments, the gradient may be estimated by:

$${∇}_{W} L ( W ) = \tilde{R} - {\sum }_{τ ∈ h} \frac{U ( τ ) {π ( τ )}^{- 1} {e}^{{W}^{T} \hat{R} ( τ )}}{{\sum }_{τ ∈ h} U ( {τ}^{′} ) {π ( {τ}^{′} )}^{- 1} {e}^{{W}^{T} \hat{R} ( {τ}^{′} )}} \hat{R} ( τ ) \qquad ( 11 )$$

The weight vector W=(\tilde{w}₁, \tilde{w}₂) may be learned by iteratively applying the above IRL algorithm.

Returning to FIG. 1, the value functions component 116 may be configured to jointly learn a first value function and a second value function using DRL based on the historical driver trajectories and the weight vector. The first value function and the second value function may include distributions of expected returns of future dispatch decisions.

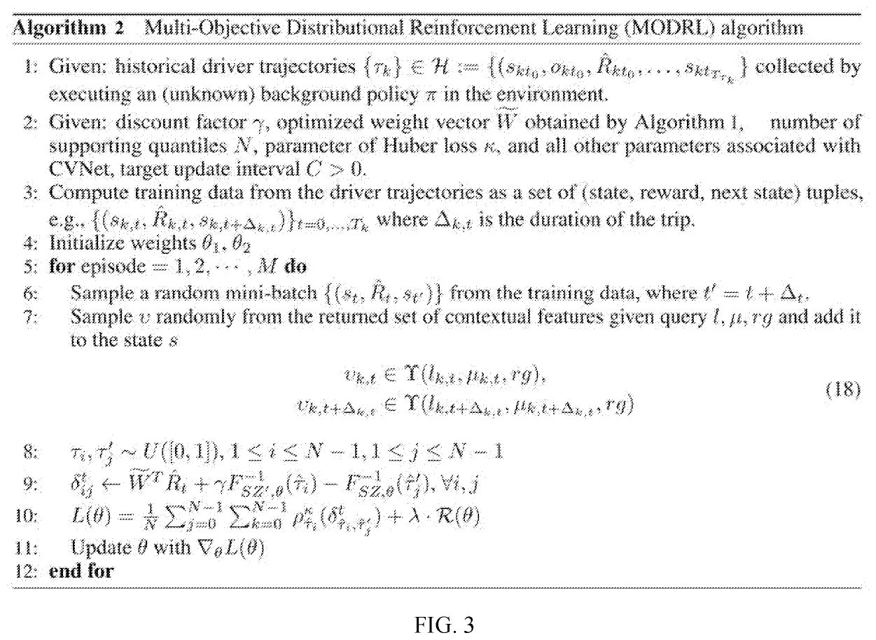

FIG. 3 illustrates an exemplary algorithm for MODRL, in accordance with various embodiments. In some embodiments, the algorithm may be implemented by the value functions component 116 of FIG. 1. In some embodiments, MODRL may incorporate CVNet with Implicit Quantile Networks (IQN) to jointly learn the value function V₁, V₂ and SV. In some embodiments, jointly learning the first value function and the second value function using DRL based on the historical driver trajectories and the weight vector may include obtaining a subset of trajectories from the set of historical driver trajectories. A set of augmented trajectories may be obtained by augmenting the subset of trajectories with contextual features. A trajectory probability may be determined by sampling a range from the set of augmented trajectories. For example, a uniform distribution may be sampled between 0 and 1. A weighted temporal difference (TD) error may be determined based on the trajectory probability. A loss may be determined based on the weighted TD error. The first weights of the first value function and second weights of the second value function may be updated based on the gradient of the loss.

Under the framework of MOSMDP, option oₜ may be selected at each state sₜ following the background policy π. The scalarization function ƒ may be applied to the state-action distribution Z^{π}(s) to obtain a single return SZ^{π}(s; \tilde{W}), which is the weighted-sum of Z₁^{π}(s) and Z₂^{π}(s), formally:

$${SZ}^{π} ( s ; \tilde{W} ) = {\sum }_{i = 1}^{2} {\tilde{w}}_{i} {Z}_{i}^{π} ( s ) \qquad ( 12 )$$

The expectation of SZ^{π}(s; \tilde{W}) (i.e., the state value function) may be given by:

$$\begin{matrix}{SV}^{π} ( s ; \tilde{W} ) = E ( {SZ}^{π} ( s : \tilde{W} ) ) \\ = {\sum }_{i = 1}^{2} {\tilde{w}}_{i} E ( {Z}_{i}^{π} ( s ) ) = {\sum }_{i = 1}^{2} {\tilde{w}}_{i} {V}_{i}^{π} ( s )\end{matrix} \qquad ( 13 )$$

In some embodiments, the distribution of Vᵢ may be modeled a weighted mixture of N Diracs. For example:

$${V}_{q , τ}^{i} ( s ) : {=}^{D} {\sum }_{j = 0}^{N - 1} ( {τ}_{j + 1} - {τ}_{j} ) {δ}_{{q}_{ij}} ( s ) for i ∈ \{ 1 , 2 \} , \qquad ( 14 )$$

where δ_{z} denotes a Dirac at z∈R, and τ₁, . . . , τ_{N} represent the N adjustable fractions satisfying τⱼ₋₁<τⱼ. In some embodiments,

$${\hat{τ}}_{j} = \frac{{τ}_{j} + {τ}_{j + 1}}{2} ,$$

and the optimal corresponding quantile values qᵢⱼ may be given by qᵢⱼ=F_{Z}_{ᵢ}⁻¹(\hat{τ}ⱼ) where F_{Z}_{ᵢ}⁻¹, i=1, 2 is the inverse function of cumulative distribution function F_{Z}_{ᵢ}(z)=Pr(Zᵢ<z). In some embodiments, IQN may be used to train the quantile functions. The main structure of CVNet may be used to learn the state embedding Ψ: S→R^{d}, and compute the embedding of τ, denoted by ϕ(τ), with

$${ϕ}_{j} ( τ ) := Re Lu ( {\sum }_{i = 0}^{n - 1} cos ( π i τ ) {w}_{ij} + {b}_{j} ) \qquad ( 15 )$$

The element-wise (Hadamard) product of state feature (s) and embedding (τ) may then be computed, and the approximation of the quantile values may be obtained by F_{Z}_{ᵢ}_{,θ}_{ᵢ}(τ)=ƒ(ψ(s) ⊙ ϕ(τ)); i=1; 2. θᵢ may contain all the parameters to be learned. The weighted TD error for two probabilities z and may be defined by:

δ_{i,τ,τ′}^{t}=Rᵢ(sₜ,oₜ)+γ^{Δ}^{ₜ}F_{Z′}_{ᵢ}_{,θ}_{ᵢ}⁻¹(τ)−F_{Z}_{ᵢ}_{,θ}_{ᵢ}⁻¹(τ′),∀i=1,2 (16)

The quantile value networks may be trained by minimizing the Huber quantile regression loss

$${ρ}_{τ}^{k} ( {δ}_{i , τ , {τ}^{′}} ) = \vert τ - \{ {δ}_{i , τ , {τ}^{′}} < 0 \} \vert \frac{{ℒ}_{k} ( {δ}_{i , τ , {τ}^{′}} )}{k} \qquad ( 17 )$$

where [symbol] is the indicator function and [symbol] _{κ} is the Huber loss,

$${ℒ}_{k} ( x ) = \{ \begin{matrix}\frac{1}{2} {x}^{2} , & if x \leq k ; \\ k ( \vert x \vert - \frac{1}{2} k ) , & otherwise .\end{matrix} \qquad ( 18 )$$

In some embodiments, at each time step t, the loss of the quantile value network for the i-th objective may be defined as follows:

$${L}_{i} ( {s}_{t} , {o}_{t} , {r}_{t} , {s}_{t + Δ t} ; {θ}_{i} ) = \frac{1}{N} {\sum }_{k = 0}^{N - 1} {\sum }_{j = 0}^{N - 1} {ρ}_{{\hat{τ}}_{k}}^{k} ( {δ}_{i , {\hat{τ}}_{k} , {\hat{τ}}_{j}^{′}}^{t} ) , ∀ i = 1 , 2 \qquad ( 19 )$$

where τᵢ, τ′ⱼ˜U([0, 1]).

The equation (13) shows that SZ can be factorized as the weighted sum of Vᵢ. In some embodiments, the learning of distributional RL may exploit this structure directly. The observation that the expectation of a random variable can be expressed as an integral of the quantiles may be used, e.g., Vᵢ=∫₀¹F_{Z}_{ᵢ}⁻¹(τ)d̅τ. This observation may be applied to equation (13) using the Monte Carlo estimate to obtain:

$$\begin{matrix}{SV}^{π} ( s ; \tilde{W} ) = {\sum }_{i = 1}^{2} {\tilde{w}}_{i} {V}_{i}^{t} ( s ) \\ = {\sum }_{i = 1}^{2} {\tilde{w}}_{i} {\int }_{0}^{1} {F}_{{Z}_{i}^{τ} ( s )}^{- 1} ( τ ) d τ \approx {\sum }_{i = 1}^{2} {\tilde{w}}_{i} \frac{1}{N} {\sum }_{k = 0}^{N - 1} {F}_{{Z}_{i}^{τ} ( s )}^{- 1} ( {τ}_{k} )\end{matrix} \qquad ( 20 )$$

where N may include the Monte Carlo sample size and m may be sampled from the uniform distribution U([0, 1]), e.g., τₖ˜U([0, 1]). The temporal difference (TD) error for SV may be defined by

$$\begin{matrix}{δ}_{SV , τ , {τ}^{′}} = R ( {s}_{t} , {o}_{t} ) + {γ}^{{Δ}_{t}} {SV}^{π} ( {s}_{t} ; \tilde{W} ) - {SV}^{π} ( {s}_{t} ; \tilde{W} ) \\ = R ( {s}_{t} , {o}_{t} ) + {\sum }_{i = 1}^{2} {\tilde{w}}_{i} \frac{1}{N} {\sum }_{k = 0}^{N - 1} {F}_{{Z}_{i}^{τ} ( {s}_{{t}^{′}} ) , {θ}_{i}}^{- 1} ( {τ}_{k}^{′} ) - {\sum }_{i = 1}^{2} {\tilde{w}}_{i} \frac{1}{N} {\sum }_{k = 0}^{N - 1} {F}_{{Z}_{i}^{τ} ( {s}_{t} ) , {θ}_{i}}^{- 1} ( {τ}_{k} )\end{matrix} \qquad ( 21 )$$

The final joint training objective regarding Z₁, Z₂ and SZ may be given by

$$\begin{matrix}L ( θ ) = {L}_{1} ( {θ}_{1} ) + {L}_{2} ( {θ}_{2} ) + {L}_{SV} ( θ ) + X ℛ ( θ ) \\ = \frac{1}{N} {\sum }_{k = 0}^{N - 1} {\sum }_{j = 0}^{N - 1} {ρ}_{{\hat{τ}}_{k}}^{k} ( {δ}_{1 , {\hat{τ}}_{k} , {\hat{τ}}_{j}^{′}}^{t} ) + \frac{1}{N} {\sum }_{k = 0}^{N - 1} {\sum }_{j = 0}^{N - 1} {ρ}_{{\hat{τ}}_{k}}^{k} ( {δ}_{2 , {\hat{τ}}_{k} , {\hat{τ}}_{j}^{′}}^{t} ) + {ℒ}_{k} ( {δ}_{SV , \hat{τ} , {\hat{τ}}^{′}}^{t} ) + λℛ ( θ )\end{matrix} \qquad ( 22 )$$

where θ is the concatenation of θ₁ and θ₂. R(θ) may include an added penalty term to control the global Lipschitz constant in Ψ(s) and λ>0 is a hyper-parameter. Equation (22) may incorporate the information of both the two separate distributions and the joint distribution.

Returning to FIG. 1, the dispatch decision component 118 may be configured to determine a set of scores comprising a score of each driver-order pair in the set of driver-order pairs based on the weight vector, the first value function, and the second value function. In some embodiments, each driver order pair may include a driver and an order. The score of each driver-order pair may be based on the TD error between an expected return if the driver of the driver-order pair accepts the pending order and an expected return if the driver stays idle. In some embodiments, the TD error may be computed using equation (26) below, where Ai is the corresponding TD error for each Vi.

The dispatch decision component 118 may further be configured to determine a set of dispatch decisions based on the set of scores that maximizes a total reward of the set of dispatch decisions. Each dispatch decision in the set of dispatch decisions may include at least matching an available driver to a passenger. In some embodiments, the passenger may be matched with a plurality of available drivers. For example, the passenger may be matched with more than one (e.g. 2, 3, or more) driver so that one of these drivers may choose whether to take this passenger or not. In some embodiments, a plurality of passengers may be matched with one driver (e.g., ride-pooling). In some embodiments, the set of dispatch decisions may be added to the set of historical driver trajectories for a next iteration. Offline training and online planning may be iterated between to continuously improve the policy (e.g., the weight vector and the value functions). The offline training may include jointly learning the value functions, and the online planning may include determining the dispatch decisions.

In some embodiments, the order-dispatching system of ride-hailing platforms may include a multi-agent system with multiple drivers making decisions across time. The platform may optimally assign orders collected within each small time window to the nearby idle drivers, where each ride request cannot be paired with multiple drivers to avoid assignment conflicts. A utility score pᵢⱼ may be used to indicate the value of matching each driver i to an order j, and the global dispatching algorithm may equivalent to solving a bipartite matching problem as follows:

$$\begin{matrix}arg {max}_{{x}_{ij}} {\sum }_{j = 0}^{M} {\sum }_{k = 0}^{N} {ρ}_{jk} {x}_{jk} , \\ s . t . {\sum }_{j = 0}^{M} {x}_{jk} \leq 1 ∀ k ; {\sum }_{k = 0}^{N} {x}_{jk} \leq 1 ∀ j ; & ( 23 ) \\ where & \\ {x}_{jk} = \{ \begin{matrix}1 & if order j is assigned to driver k ; \\ 0 & if order j is not assigned to driver k .\end{matrix} & ( 24 )\end{matrix}$$

where the last two constraint may ensure that that each order can be paired to at most one available driver and similarly each driver can be assigned to at most one order. This problem can be solved by standard matching algorithms (e.g., the Hungarian Method).

In some embodiments, the value advantage between the expected return from when a driver k accepts order j and when the driver stays idle may be computed as the TD (Temporal Difference) error Ai(j, k) for the i-th objective, and the utility function pⱼₖ may be computed as:

ρⱼₖ=w₁A₁(j,k)+w₂A₂(j,k)+Ω·Uⱼₖ (25)

where

Aᵢ(j,k)=\hat{R}_{i,jk}+γ^{k}^{ⱼₖ}Vᵢ(sₖ)−Vᵢ(sⱼ) for i∈{1,2} 26)

$${\dot{R}}_{i , jk} = {R}_{i , jk} \frac{( {γ}^{{k}_{jk}} - 1 )}{{k}_{ij} ( γ - 1 )} ,$$

i∈{1, 2}, where R_{1,jk} may include the trip fee collected after the driver k delivers order j and R_{2,jk} may include the spatial-temporal relationship in the destination location of order j. Both R_{1,jk} and R_{2,jk} may be replaced by their predictions when calculating the utility score (e.g., in equation (26)). kⱼₖ may represent the time duration of the trip. Uⱼₖ may characterize the user experience from both the driver k and the passenger j so that not only the driver income but also the experience for both sides may be optimized. The optimal (w1, w2) may be determined to maximize some platform metrics (e.g., order dispatching rate, passenger waiting time, and driver idle rates) to optimize the market balance and users' experience.

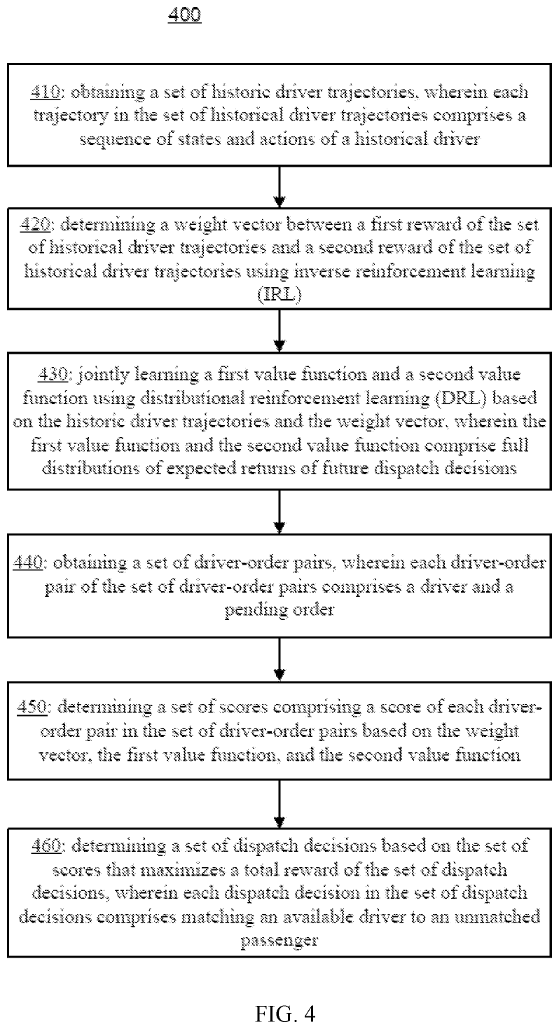

FIG. 4 illustrates a flowchart of an exemplary method 400, according to various embodiments of the present disclosure. The method 400 may be implemented in various environments including, for example, the system 100 of FIG. 1. The method 400 may be performed by computing system 102. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, a set of historical driver trajectories, wherein each trajectory in the set of historical driver trajectories comprises a sequence of states and actions of a historical driver. At block 420 a weight vector between a first reward of the set of historical driver trajectories and a second reward of the set of historical driver trajectories may be determined using inverse reinforcement learning (IRL). At block 430, a first value function and a second value function may be jointly learned using distributional reinforcement learning (DRL) based on the historical driver trajectories and the weight vector, wherein the first value function and the second value function comprise full distributions of expected returns of future dispatch decisions. At block 440, a set of driver-order pairs may be obtained, wherein each driver-order pair of the set of driver-order pairs comprises a driver and a pending order. At block 450, a set of scores comprising a score of each driver-order pair in the set of driver-order pairs may be determined based on the weight vector, the first value function, and the second value function. At block 460, a set of dispatch decisions may be determined based on the set of scores that maximizes a total reward of the set of dispatch decisions, wherein each dispatch decision in the set of dispatch decisions comprises matching an available driver to an unmatched passenger.

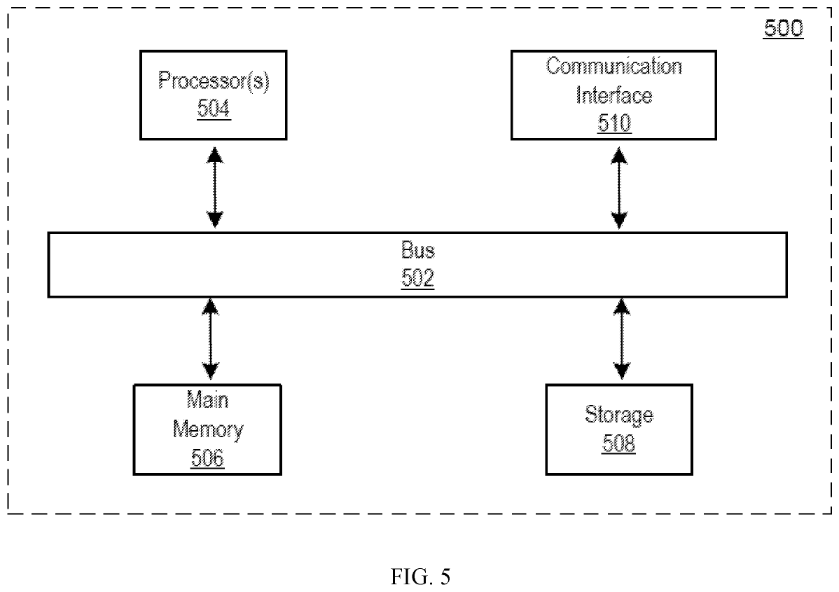

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102, the information obtaining component 112, the weight vector component 114, the value functions component 116, and the dispatch decision component 118. shown in FIG. 1. As another example, the process/method shown in FIGS. 2-4 and described in connection with this figure may be implemented by computer program instructions stored in main memory 506. When these instructions are executed by processor(s) 504, they may perform the steps of method 400 as shown in FIG. 4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for order dispatching, comprising:
obtaining a set of historical driver trajectories, wherein each trajectory in the set of historical driver trajectories comprises a sequence of states and actions of a historical driver;
determining a weight vector between a first reward of the set of historical driver trajectories and a second reward of the set of historical driver trajectories using inverse reinforcement learning (IRL);
jointly learning a first value function and a second value function using distributional reinforcement learning (DRL) based on the historical driver trajectories and the weight vector, wherein the first value function and the second value function comprise distributions of expected returns of future dispatch decisions;
obtaining a set of driver-order pairs, wherein each driver-order pair of the set of driver-order pairs comprises a driver and a pending order;
determining a set of scores comprising a score of each driver-order pair in the set of driver-order pairs based on the weight vector, the first value function, and the second value function; and
determining a set of dispatch decisions based on the set of scores that maximize a total reward of the set of dispatch decisions, wherein each dispatch decision in the set of dispatch decisions comprises at least matching an available driver to a passenger.

2. The method of claim 1, wherein the set of historical driver trajectories occurred under an unknown background policy.

3. The method of claim 1, wherein the first reward corresponds to collected total fees and the second reward corresponds to a supply and demand balance.

4. The method of claim 1, wherein the weight vector is determined iteratively by using IRL to match estimations of action-state sequences to the set historical driver trajectories.

5. The method of claim 1, wherein jointly learning the first value function and the second value function using DRL based on the historical driver trajectories and the weight vector comprises:
obtaining a subset of trajectories from the set of historical driver trajectories;
obtaining a set of augmented trajectories by augmenting the subset of trajectories with contextual features;
determining a trajectory probability by sampling a range from the set of augmented trajectories;
determining a weighted temporal difference (TD) error based on the trajectory probability;
determining a loss based on the weighted TD error; and
updating first weights of the first value function and second weights of the second value function based on the gradient of the loss.

6. The method of claim 5, wherein jointly learning the first value function and the second value function using DRL based on the historical driver trajectories and the weight vector further comprises:
determining first optimal values of the first weights of the first value function and second optimal values of the second weights of the second value function to optimize at least one of order dispatching rate, passenger waiting time, or driver idle rates.

7. The method of claim 1, wherein the score of the driver-order pair is based on a TD error between an expected return if the driver of the driver-order pair accepts the pending order and an expected return if the driver stays idle.

8. The method of claim 1, wherein the passenger is matched with a plurality of available drivers.

9. The method of claim 1, further comprising adding the set of dispatch decisions to the set of historical driver trajectories to re-determine the weight vector and re-learn the first value function and the second value function for dispatching a new set of driver-order pairs.

10. A system for order dispatching, comprising one or more processors and one or more non-transitory computer-readable memories coupled to the one or more processors and configured with instructions executable by the one or more processors to cause the system to perform operations comprising:
obtaining a set of historical driver trajectories, wherein each trajectory in the set of historical driver trajectories comprises a sequence of states and actions of a historical driver;
determining a weight vector between a first reward of the set of historical driver trajectories and a second reward of the set of historical driver trajectories using inverse reinforcement learning (IRL);
jointly learning a first value function and a second value function using distributional reinforcement learning (DRL) based on the historical driver trajectories and the weight vector, wherein the first value function and the second value function comprise distributions of expected returns of future dispatch decisions;
obtaining a set of driver-order pairs, wherein each driver-order pair of the set of driver-order pairs comprises a driver and a pending order;
determining a set of scores comprising a score of each driver-order pair in the set of driver-order pairs based on the weight vector, the first value function, and the second value function; and
determining a set of dispatch decisions based on the set of scores that maximizes a total reward of the set of dispatch decisions, wherein each dispatch decision in the set of dispatch decisions comprises at least matching an available driver to a passenger.

11. The system of claim 10, wherein the set of historical driver trajectories occurred under an unknown background policy.

12. The system of claim 10, wherein the first reward corresponds to collected total fees and the second reward corresponds to a supply and demand balance.

13. The system of claim 10, wherein the weight vector is determined iteratively by using IRL to match estimations of action-state sequences to the set historical driver trajectories.

14. The system of claim 10, wherein jointly learning the first value function and the second value function using DRL based on the historical driver trajectories and the weight vector comprises:
obtaining a subset of trajectories from the set of historical driver trajectories;
obtaining a set of augmented trajectories by augmenting the subset of trajectories with contextual features;
determining a trajectory probability by sampling a range from the set of augmented trajectories;
determining a weighted TD error based on the trajectory probability;
determining a loss based on the weighted TD error; and
updating first weights of the first value function and second weights of the second value function based on the gradient of the loss.

15. The system of claim 14, wherein jointly learning the first value function and the second value function using DRL based on the historical driver trajectories and the weight vector further comprises:
determining first optimal values of the first weights of the first value function and second optimal values of the second weights of the second value function to optimize at least one of order dispatching rate, passenger waiting time, or driver idle rates.

16. The system of claim 10, wherein the score of the driver-order pair is based on a TD error between an expected return if the driver of the driver-order pair accepts the pending order and an expected return if the driver stays idle.

17. A non-transitory computer-readable storage medium configured with instructions executable by one or more processors to cause the one or more processors to perform operations comprising:
obtaining a set of historical driver trajectories, wherein each trajectory in the set of historical driver trajectories comprises a sequence of states and actions of a historical driver;
determining a weight vector between a first reward of the set of historical driver trajectories and a second reward of the set of historical driver trajectories using inverse reinforcement learning (IRL);
jointly learning a first value function and a second value function using distributional reinforcement learning (DRL) based on the historical driver trajectories and the weight vector, wherein the first value function and the second value function comprise distributions of expected returns of future dispatch decisions;
obtaining a set of driver-order pairs, wherein each driver-order pair of the set of driver-order pairs comprises a driver and a pending order;
determining a set of scores comprising a score of each driver-order pair in the set of driver-order pairs based on the weight vector, the first value function, and the second value function; and
determining a set of dispatch decisions based on the set of scores that maximizes a total reward of the set of dispatch decisions, wherein each dispatch decision in the set of dispatch decisions comprises at least matching an available driver to a passenger.

18. The non-transitory computer-readable storage medium of claim 17, wherein the first reward corresponds to collected total fees and the second reward corresponds to a supply and demand balance.

19. The non-transitory computer-readable storage medium of claim 17, wherein the weight vector is determined iteratively by using IRL to match estimations of action-state sequences to the set historical driver trajectories.

20. The non-transitory computer-readable storage medium of claim 17, wherein jointly learning the first value function and the second value function using DRL based on the historical driver trajectories and the weight vector comprises:
obtaining a subset of trajectories from the set of historical driver trajectories;
obtaining a set of augmented trajectories by augmenting the subset of trajectories with contextual features;
determining a trajectory probability by sampling a range from the set of augmented trajectories;
determining a weighted TD error based on the trajectory probability;
determining a loss based on the weighted TD error; and
updating first weights of the first value function and second weights of the second value function based on the gradient of the loss.
